(19) United States
(12) Patent Application Publication
(10) Pub. No.: US 2014/0075348 A1
(43) Pub. Date: Mar. 13, 2014

(54) METHOD AND APPARATUS FOR ASSOCIATING EVENT TYPES WITH PLACE TYPES

(71) Applicant: Sailesh Sathish, Tampere (FI)

(72) Inventor: Sailesh Sathish, Tampere (FI)

(73) Assignee: Nokia Corporation, Espoo (FI)

(21) Appl. No.: 13/609,479

(22) Filed: Sep. 11, 2012

(51) Int. Cl. G06F 3/0481

(52) U.S. Cl. CPC G06F 3/0481
USPC 715/764

(57) ABSTRACT

An approach for identifying and subscribing to events of varying types/contexts based on a user selected place type is described. A place based event platform determines a user input for specifying at least one place type to associate with a user selection of a map, a portion of the map, or a combination thereof. The place based event platform further processes the at least one place type to determine one or more context types, one or more event types, or a combination thereof associated with the map, the portion of the map, or a combination thereof.

### BACKGROUND

Service providers and device manufacturers (e.g., wireless, cellular, etc.) are continually challenged to deliver value and convenience to consumers by, for example, providing compelling network services. One area of interest is providing device users with access to information regarding events based on areas of interest to the user or their current location. Unfortunately, while device users may view specific areas or locations of interest via a map application, there is currently no means of enabling users to readily identify and subscribe to events of varying types/contexts that are related to these areas or locations.

### SOME EXAMPLE EMBODIMENTS

Therefore, there is a need for enabling a user to identify and subscribe to events of varying types/contexts based on a user selected place type.

According to one embodiment, a method comprises determining a user input for specifying at least one place type to associate with a user selection of a map, a portion of the map, or a combination thereof. The method further comprises processing and/or facilitating a processing of the at least one place type to determine one or more context types, one or more event types, or a combination thereof associated with the map, the portion of the map, or a combination thereof.

According to another embodiment, an apparatus comprises determining a user input for specifying at least one place type to associate with a user selection of a map, a portion of the map, or a combination thereof. The apparatus is also further caused to process and/or facilitate a processing of the at least one place type to determine one or more context types, one or more event types, or a combination thereof associated with the map, the portion of the map, or a combination thereof.

According to another embodiment, a computer-readable storage medium carries one or more sequences of one or more instructions which, when executed by one or more processors, cause, at least in part, an apparatus to determine a user input for specifying at least one place type to associate with a user selection of a map, a portion of the map, or a combination thereof. The apparatus is further caused to process and/or facilitate a processing of the at least one place type to determine one or more context types, one or more event types, or a combination thereof associated with the map, the portion of the map, or a combination thereof.

According to another embodiment, an apparatus comprises means for determining a user input for specifying at least one place type to associate with a user selection of a map, a portion of the map, or a combination thereof. The apparatus further comprises means for processing and/or facilitating a processing of the at least one place type to determine one or more context types, one or more event types, or a combination thereof associated with the map, the portion of the map, or a combination thereof.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of enabling a user to identify and subscribe to events of varying types/contexts based on a user selected place type, according to one embodiment;

FIG. 2 is a diagram of the components of a place based event platform, according to one embodiment;

FIGS. 3A-3D are flowcharts of processes for enabling a user to identify and subscribe to events of varying types/contexts based on a user selected place type, according to various embodiments;

FIGS. 4A-4C are diagrams of user interfaces utilized in the processes of FIGS. 3A-3D, according to various embodiments;

FIG. 5 is a diagram of hardware that can be used to implement an embodiment of the invention;

FIG. 6 is a diagram of a chip set that can be used to implement an embodiment of the invention; and

FIG. 7 is a diagram of a mobile terminal (e.g., handset) that can be used to implement an embodiment of the invention.

### DESCRIPTION OF SOME EMBODIMENTS

Examples of a method, apparatus, and computer program for enabling a user to identify and subscribe to events of varying types/contexts based on a user selected place type are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to place types (e.g., areas and/or locations) presented via a mapping application, it is contemplated the approach described herein may be used with any service for supporting route navigation, location finding, event mapping or the like.

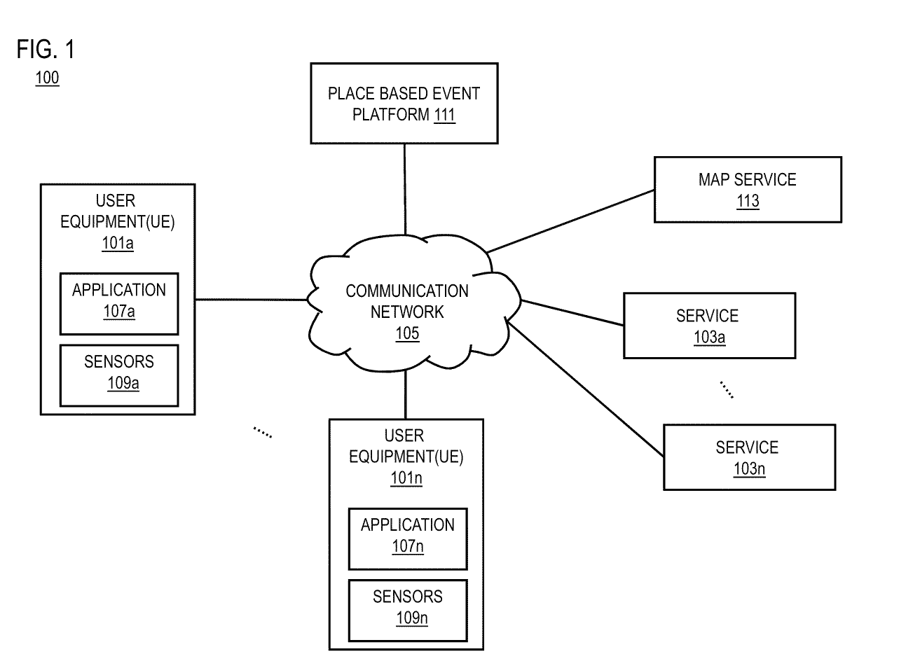

FIG. 1 is a diagram of a system capable of enabling a user to identify and subscribe to events of varying types/contexts based on a user selected place type, according to one embodiment. By way of example, a place type may include a location, a geographic range or a geographic area as presented via a two or three dimensional map. As such, a place type may encompass multiple different locations or points-of-interest (POI) within a given geographic range or area. For example, a place type may include a single location or POI as shown on a map or multiple locations or POIs. Still further, the place type may be associated with a context type for characterizing or describing the location or POI. As such, a place type defines which context types may be supported for presentment via a map service. For example, an “Industrial” context type may define a place type that includes various industrial buildings, factories and manufacturing facilities. As another example, a “Business” context type may pertain to a place type featuring various businesses and office buildings. As yet another example, an “Art” context type may pertain to a place type that includes various art galleries, art boutiques and the like.

In contrast, however, the “Art” context type may also pertain to a place type that includes as a bowling alley or farm. It is noted, therefore, that is it not necessary that a place type be present for a selected content type. Rather, as will be discussed, enabling user selection of a place type via a map signifies that only certain context types belonging to those place types are active. As such, one place type may be associated with multiple context types.

Typically, device users rely on map services to access maps for depicting and identifying different place types. For example, a user may specify a zip code or name of a city to be shown as a map view of the place type. The rendered map may include various objects, text and map elements for depicting roadways, buildings, landmarks, etc. Users may hone in on certain sections of the map or expand the map view by adapting the granularity of the view or highlighting specific section of the map. In addition, some map services feature filtering tools for enabling users to identify specific points of interest by context type. For example, a user may select a “Restaurants Nearby” link of the map service to cause the map to depict the locations of restaurants within the defined place type. Unfortunately, users are limited in their ability to define their own unique context type for influencing the generation of a map. Still further, users currently have no way of identifying specific types of events that may be occurring and/or scheduled to occur based on a chosen place type or context thereof. Nor do they have an effective means of subscribing to events of varying types/contexts that are related to a selected place type.

To address this problem, a system 100 of FIG. 1 introduces the capability for users of user devices, such as user equipment (UE) 101a-101n, to define context types for influencing the generation and/or rendering of maps by a map service 113. In addition, the system 100 enables users of UE 101a-101n, referred to herein collectively as UE 101, to identify and subscribe to event types related to a specified context type. By way of example, the system 100 includes a place based event platform 111, which operates in connection with the UE 101, a mapping service 113 and various other third-party data providers (e.g., services 103a-103n) to enhance a user's ability to access contextually relevant event information directly through the map service 113. Under this scenario, the place based event platform 111 accessed one or more models (e.g., ontology, data templates, etc.) for managing and identifying the relationship between different places, contexts and event types. The relationship between the different types is presented, by way of example, as follows:

Place Type→Context Type→Event Type

In this case, a selected place-type determines/defines the available context types for a given place type. Furthermore, each context type is further associated with one or more event-types for defining what events, activities and/or venues are available for a selected context type. By having predefined events for each type of context for a given place type, the system 100 ensures a uniform vocabulary (semantics, ontology, etc.) for all events is maintained. In addition, the place based event platform 111 may be employed as a means of facilitating crowd-sourcing events.

As will be discussed further later on, the place based event platform 111 may execute one or more application programming interfaces (APIs), data processes and/or instruction sets for adapting and/or affecting how the user experiences the map service 113. It is noted, therefore, that the place based event platform 111 may be integrated within the map service 113 or maintained as an independent service (e.g., web service) capable of being called by the map service 113 at the request of a UE 101.

In certain embodiments, the place based event platform 111 interacts with a map service 113 to enable users of UE 101 to generate maps based on one or more selected context types. By way of example, the place based event platform 111 facilitates processing of a user selected place type to identify one or more context types associated with the place type. Under this scenario, when the map service 113 is launched by an application 107a-107n (referred to herein collectively as application 107) via UE 101, the map service 113 may feature one or more data entry fields for enabling a user to input a place type of interest (e.g., a “Destination” data entry field). The input may include an address, zip code, city, state or other location related data. In other instances, the input may include a name of POI (e.g., “Willis Tower”) or a description of an intersection or cross street for a given region.

Based on this input, the map service 113 generates a map (e.g., map view) for depicting the specified place type. Of note, the entire map as generated may represent the place type of interest to the user corresponding to the input. Alternatively, the user may further select a portion of the map to represent the place type by highlighting, zooming or focusing upon a specific region of the generated map. In either instance, the place based event platform 111 is called to compare the input (specified place type) provided to the map service 113 against a list of predefined context types to identify one or more matches. This matching may include, for example, identifying a mapping between the input and a specific data file corresponding to a particular context type, comparing of the input (e.g., a text string) against one or more tag definitions for defining one or more context types, or a combination thereof.

By way of example, the predefined context types are established by one or more data service providers, i.e., location service providers, event service providers, advertisers, news service providers, social networking providers or the like. The service providers establish services 103a-103n, referred to herein collectively as services 103, to provide data to the map service 113 for use in generating maps. Provisioning of the data may be based on a data sharing arrangement between the provider of the map service 113 and the provider of the services 103. Per this arrangement, the services 103 define various context types to be associated with a given place type. In addition, the specific data files associated with a given place type as well as the type of data available for use in constructing a map per the selected place type is defined per the arrangement (e.g., semantics, data types, data formats). Examples of different context types are shown, by way of example, in Table 1 below.

TABLE 1

Tourist
Shopping
Leisure
Entertainment
General
Kids
Lifestyle
Home
Fashion
Sports
Arts
Social
Health

The place based event platform 111 presents the context types that match the selected place type to the user interface rendered by the application 107. Hence, the context types are rendered to the user interface concurrent with the map or portion thereof generated by the map service 113 per the selected place type. As such, the context types may be rendered to the user interface as one or more action buttons, active links or other executable/interactive elements capable of being selected by the user. When a user of UE 101 selects a particular context type, the place based event platform 111 requests an updated rendering of the map that features data only related to the selected context type. Under this scenario, if the user chooses the “Shopping” context type, then only data (e.g., points-of-interest, objects, textual descriptors) pertaining to super markets, shops, shopping offers, shop parking information, shopping chats and the like will be presented in connection with the map. Thus, selection of a context type acts as a filter for presenting only contextually relevant data to the user with respect to a selected place type.

In certain embodiments, the place based event platform 111 may also support the defining of one or more subcategories of context types per the services 103. By way of example, a subcategory may represent a finer/granular designation for a given context type. Hence, in the case of the “Shopping” context type, various subcategories may include “Shoes,” “Clothing” or “Gadgets.” The place based event platform 111 renders one or more action buttons, active links or other executable/interactive elements for enabling user selection of the various subcategories concurrent with the map/selected place type.

In certain embodiments, the user may create an entirely new context type by providing as input, one or more information types and/or data definitions. The one or more information types and/or data definitions may be presented to the user as one or more data entry fields for receiving user input via the application 107. By way of example, a NAME information type may be presented for enabling the user to input a name of a context type to be defined. As another example, a DESCRIPTION information type may be presented for enabling user input of one or more tags and/or labels for describing the context type. Similarly, various data entry fields may be presented for defining one or more subcategories to associate with a context type. It is noted that the information types and/or data definitions may be specified by the one or more services 103, i.e., as definition templates for receiving the user input. As such, the place based event platform 111 may process the definition templates for enabling rendering of the various data entry fields concurrent with presentment of a place type (e.g., map or portion thereof).

In certain embodiments, the place based event platform 111 also enables users to define new context types based on the combining of one or more predefined context types. As such, a user can choose one or more context types as presented via the application 107 and assign it a name. This context type is then made available for selection—i.e., from the list of context types—by the user via the. For example, per Table 1, the predefined contexts of “Social” and “Health” may be selected by the user for defining a new context type named “My Personal Health”; which then becomes an active context type selection. Under this scenario, the user can also specify whether the common subcategories of the merged context types will define the new context type, whether all subcategories of the merged context types will define the new context type, etc. Per this execution, the place based event platform 111 enables a user to select/de-select one or more context types and/or subcategories thereof via the user interface by way of keyboard, touch or other input/selection means accordingly.

In certain embodiments, the place based event platform 111 also supports the identifying and subscribing of users to event types based on a specified place type and associated context type. By way of example, when a user selects and/or defines one or more context types to associate with a selected place type, the place based event platform 111 also determines one or more event types that are associated with the selected context types. The event types may include any activities, venues or actions capable of being executed by the user currently or subsequently. The event types may be defined according to one or more ontology by the various providers of the services 103. In addition, the information related to the event may be retrieved from the services 103 and conveyed to the map for display to the user of through other communication means (e.g., event sinks).

For example, in the case of a selected subcategory context type of “Water Sports” (context type “Recreation”) for a beach related place type, one or more water sports events may be presented to the user interface of the application 107. The event information is retrieved via a lookup process carried out by the place based event platform 103 for event types conforming to the selection. Once identified, the event types corresponding to the selection may be rendered to the user interface concurrent with the map as one or more action buttons, active links or other executable/interactive elements capable of being selected by the user.

As such, when a user selects a particular event type, the place based event platform 111 requests an updated rendering of the map that features data only related to the selected context type. Under this scenario, if the user chooses the “Jet Skiing Competition” or “Aqua Sale” event type, then only data (e.g., points-of-interest, objects, textual descriptors) pertaining to these events are presented in connection with the map. Thus, selection of an event type acts as a filter for presenting only event related data to the user with respect to a selected place type and context type. It is noted that the event information for a selected event type may include, for example, details regarding the event, the location, the host of the event, participation details, etc.

In certain embodiments, the place based event platform 111 operates in connection with the services 103 to determine one or more event sinks related to a particular event type. For the purpose of illustration, an event sink may include any instructions, code, protocols or combinations thereof for directing information related to an event type to a designated location. The location may include, for example, a network location, communication port, or any other channel through which information pertaining to an event may be “sinked” (stored) in connection with the user. For example, the event sink may be related to a social networking service as specified via a network alias or handle or the user. As another example, the event sink may be an email inbox as specified per an email address of the user. Still further, the event sink may be a simple messaging service as specified via an alias, user identifier or telephone number. It is noted that the place based event platform 111 causes the application 107 to render one or more data entry fields for permitting user input of the event sink details (e.g., the alias, handle, email address, username, telephone number, etc.).

Also, of note, the only event sinks presented via the user interface concurrent with the map are those event sinks supported for the particular event type selection. As such, when the user provides the respective details, they are notified via that particular event sink when the associated event type occurs (e.g., based on event start date and time information). By way of example, one type of event sink that the user may specify is a user resource locator associated with the user for activating a script for processing event notifications. This script may interpret the event notifications and activate the appropriate channel and/or application for alerting the user based on event type and associated event sink details.

Also, depending on the types of event-sinks provided, the platform 111 may wrap the events in the appropriate format suitable for the event sink type. For example, the place based event platform may send the event information as hypertext markup language (HTML) for rendering the event information in email, while wrapping the event in a simple message service (SMS) format for transmission to a mobile phone. Similarly, event types for supporting event notifications based on the passage of arguments (e.g., event start time and date) may be wrapped according to a simple object access protocol (SOAP) format or extensible markup language (XML) format for enabling web-based and/or script executable event sinks.

In the above described embodiments, a user of UE 101 may subscribe to the place based event platform 111 to enable the various executions as described. By way of this registration procedure, the user may define a profile for supporting storing of any defined context types. In addition, the user may also maintain a log of event types they identified via the platform 111 based on a given place selection as well as event sinks to which they are subscribed. In certain embodiments, the providers of the data sources 103 may also subscribe with the place based event platform to register event types (and associated event information) or to provide extensions to event types as defined within the ontology.

As shown in FIG. 1, the system 100 comprises user equipment (UE) 101 having connectivity to the place based event platform 111 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, place based event platform 111, map service 113, applications 107 and various services 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

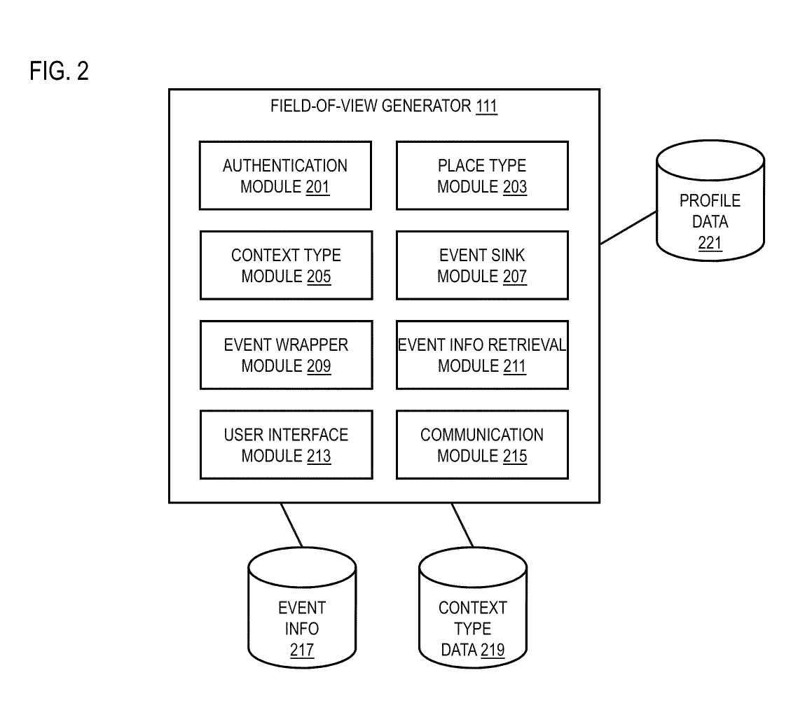

FIG. 2 is a diagram of the components of a place based event platform, according to one embodiment. By way of example, the place based event platform 111 includes one or more components for enabling a user to identify and subscribe to events of varying types/contexts based on a user selected place type. It is contemplated that the functions of these components may be combined in one or more components or performed by other components of equivalent functionality. In this embodiment, the place based event platform 111 includes an authentication module 201, place type module 203, context type module 205, event sink module 207, event wrapper module 209, event information retrieval module 211, user interface module 213 and communication module 215.

The aforementioned modules 201-215 of the place based event platform 111 may also access one or more databases 217-221 for performing various executions. This includes, for example, an event information database 217 for maintaining information related to one or more event types as retrieved by the event information retrieval module 211 from one or more services 103 as well as ontology data for defining the event types. Also included is a profile database 217 for maintaining profile information related to one or more users subscribed to and/or associated with the place based event platform 111. Still further, a context type database 219 may be maintained for storing the models (e.g., definition templates) for defining one or more context types.

In one embodiment, an authentication module 201 authenticates users and UE 101a-101n for interaction with the place based event platform 111. In addition, the authentication procedure may be performed with respect to service providers, such as a provider of the mapping service 113 or one or more data services 103. By way of example, the authentication module 201 receives a request to subscribe to the place based event platform 111 and facilitates various subscription protocols. For a user, this may include for example, establishing one or more access credentials as well as “opting-in” to receiving data from specific providers of the services 103 or the map service 113. Under this scenario, the opt-in procedure may also enable users to permit sharing of their context information (e.g., location information, position information and temporal information) as collected via one or more sensors 109 of the UE 101. In the case of a service provider, the authentication procedure may include the loading of one or more ontology to the event information database 217 along with the loading of specific event information. In addition, the procedure may include the loading of one or more data templates to the context type database 219.

Preferences and settings information may be referenced to a specific user, user device or service provider and maintained as profile data 117. It is further noted, in certain embodiments, that the subscription process may be coordinated with a subscription process of a given service 103 accessed by a user. For example, various input data required for a user to subscribe to the mapping service 113 may be used for establishing profile data 117 for the place based event platform 111; thus preventing the user from having to perform double entry of their credentials.

The authentication process performed by the module 201 may also include receiving and validating a login name and/or user identification value as provided or established for a particular user during a subscription or registration process with the service provider. The login name and/or user identification value may be received as input provided by the user from the user device 101 or other device via a graphical user interface to the place based event platform 111 (e.g., as enabled by user interface module 211). Profile data pursuant to registration may be cross referenced as part of the login process. Alternatively, the login process may be performed through automated association of profile settings maintained as profile data 217 with an IP address, a carrier detection signal of a user device, mobile directory number (MDN), subscriber identity module (e.g., of a SIM card), radio frequency identifier (RFID) tag or other identifier.

The authentication module 201 may also be alerted of an input received via the user interface of the application 107 for indicating user selection of a place type. For example, input the may be translated into a request based on a touch input for indicating an area/region of a map selected by the user. As another example, the place type may be received in connection with a request based on data entry related input of a specific location and/or point-of-interest. It is noted that the user interface module 211 supports presentment of various data entry fields and mapping elements for interpreting user input for generating a request. Also, it is noted that the request may be initiated by the map service 113 in response to a user input via the service.

In one embodiment, the place type module 203 and context type module 205 receive the user input from the authentication module 201 and performs a lookup of the related place type and context type respectively. The place type module 203 may identify one or more locations, points-of-interest (POI) or the like associated with the selected place type. So, for example, for a geographic area selected from a designated center point, the place type module 203 determines which POIs fall within that area. In certain instances, the place type module 203 may receive this data from a location determination engine of the map service 113.

The context type module 205 compares the input (specified place type) provided to the map service 113 against a list of predefined context types to identify one or more matches. This matching may include, for example, identifying a mapping between the input and a specific data file corresponding to a particular context type, comparing of the input (e.g., a text string) against one or more tag definitions for defining one or more context types, comparing of the input against one or more defined subcategories, or a combination thereof. In addition, the context type module 205 enables a user to define a new context type or merge/combine multiple predefined context types. For example, the context type module 205 may retrieve one or more context definition templates from the context type database 219. The module 205 then calls the user interface module 213 to facilitate rendering of one or more data entry fields for permitting user entry of information related to the definition template.

As another example, the context type module 205 may enable a user to select, by way of the user interface module 213, multiple predefined context types to be merged. In addition, the context type module 205 may also enable a user to specify a name for the merged/combined context types. Once the name is specified, the context type is added to the context type database 219 as a newly defined context type in connection with the profile data 221 of the user.

In one embodiment, the event sink module 207 identifies one or more event sinks for a given event type. Also, in one embodiment, the event information retrieval module 211 determines one or more event types associated with a selected context type for a place type. By way of example, the event information retrieval module performs a lookup of event types associated with the selected context type, including retrieving relevant information about the event from one or more services 103.

In one embodiment, the event wrapper module 209 wraps events based on event sink definitions, event ontology data (e.g., as maintained in the event information database 217) and any context specific data 219 rendering for specific event types. For example, the event wrapper module determines the type of event sink(s) for a given event type. Based on the event sink type, the event wrapper operates in connection with the communication module 215 to facilitate delivery of event information 217 to the event sink accordingly.

In one embodiment the user interface module 213 enables presentment of a graphical user interface for presenting the context types, event types or a combination thereof based on selection of a place type. By way of example, the user interface module 211 generates objects, map elements, icons, pictures and the like in connection with a map for representing the place type or a portion thereof. As another example, the user interface module 211 enables highlighting of a specific POI presented via the user interface. Still further, the user interface module may operate in connection with the map service 113 to enable the embedding and playback of media files, such as audio or video files, in connection with a place type.

The user interface module 213 employs various application programming interfaces (APIs) or other function calls corresponding to the application 107 of UE 101a-101n; thus enabling the display of graphics primitives such as menus, buttons, data entry fields, etc., for generating the user interface. Still further, the user interface module 213 may be configured to operate in connection with augmented reality (AR) processing techniques, wherein various different applications, graphic elements and features may interact within the same view at the UE 101. For example, the user interface module 201 may coordinate the presentment of event types conjunction with various images of a given place type in real-time as the user navigates along a route.

In one embodiment, a communication module 215 enables formation of a session over a network 105 between the place based event platform 111, the mapping service 113, the UE 101 and the services 103. By way of example, the communication module 215 executes various protocols and data sharing techniques for enabling collaborative execution between a subscriber's UE 101a-101n (e.g., mobile devices, laptops, smartphones, tablet computers, desktop computers) and the place based event platform 111 over the network 105.

The above presented modules and components of the place based event platform 111 can be implemented in hardware, firmware, software, or a combination thereof. Though depicted as a separate entity in FIG. 1, it is contemplated that the place based event platform 111 may be implemented for direct operation by respective UE 101. As such, the place based event platform 111 may generate direct signal inputs by way of the operating system of the UE 101 for interacting with the application 107. In another embodiment, one or more of the modules 201-215 may be implemented for operation by respective UEs, as a place based event platform 111, or combination thereof. Still further, the place based event platform 111 may be integrated for direct operation with a map service 113, such as in the form of a widget or applet, in accordance with an information and/or subscriber sharing arrangement. The various executions presented herein contemplate any and all arrangements and models.

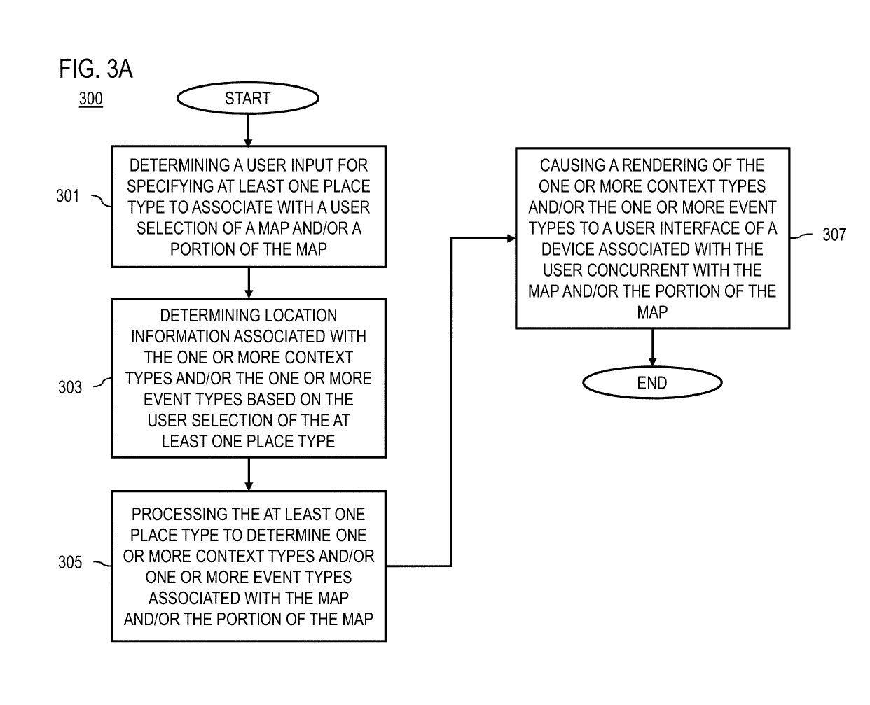

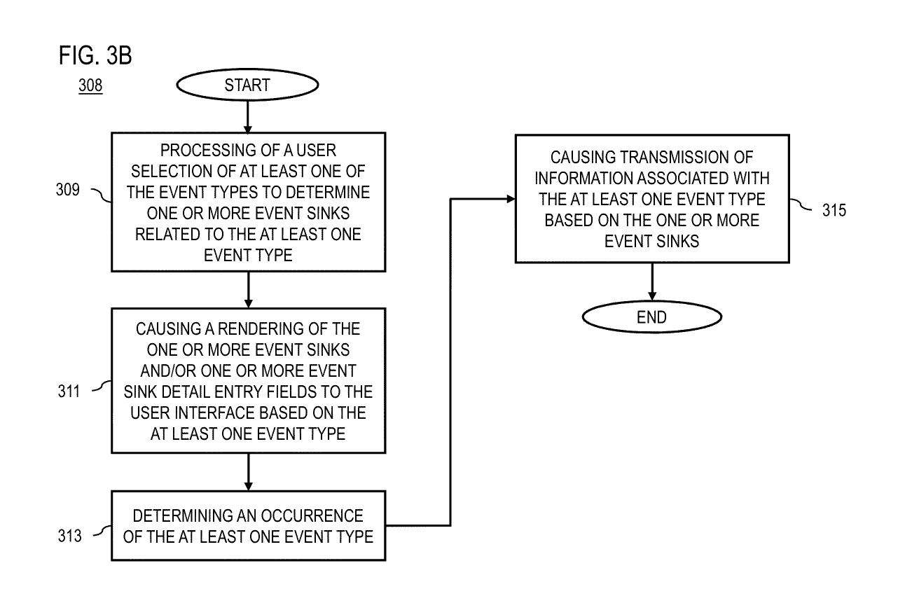

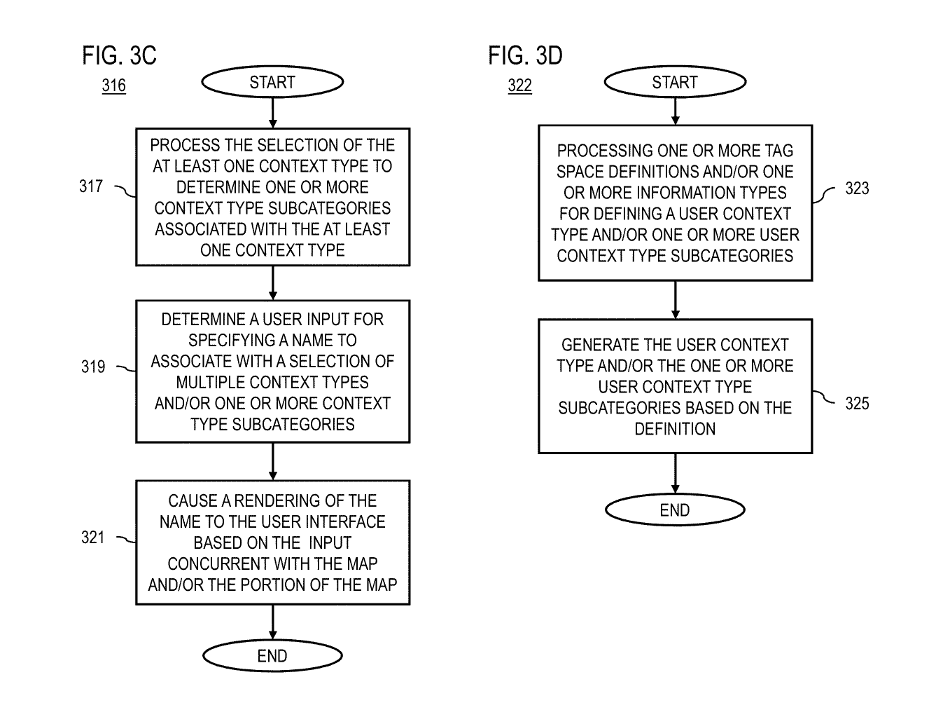

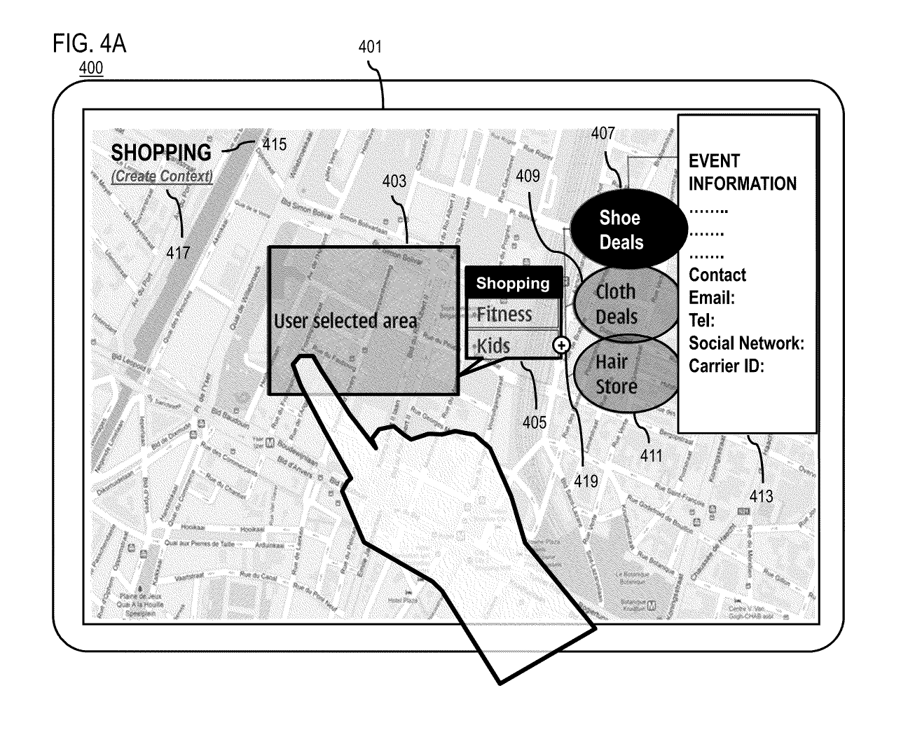

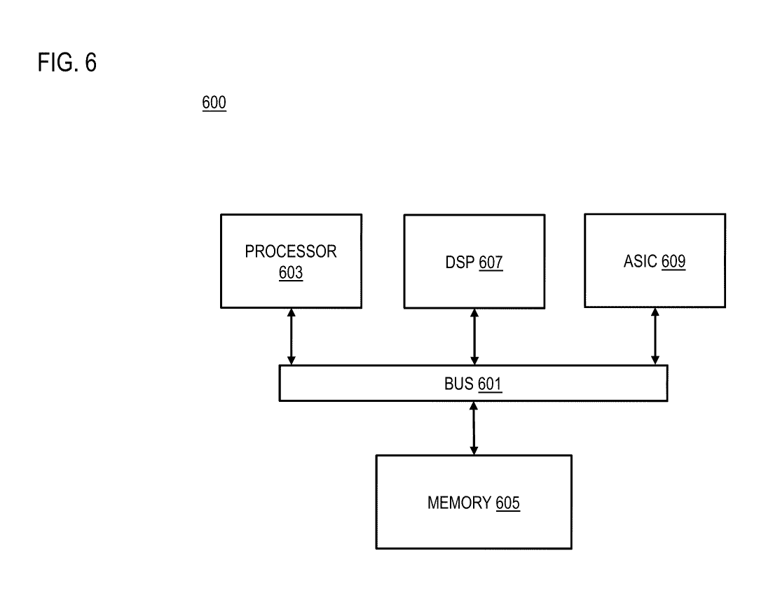

FIGS. 3A-3D are flowcharts of processes for enabling a user to identify and subscribe to events of varying types/contexts based on a user selected place type, according to various embodiments. In one embodiment, the place based event platform 111 performs processes 300, 308, 316 and 322 and is implemented in, for instance, a chip set including a processor and a memory as shown in FIG. 6.

In step 301 of process 300 (FIG. 3A), the place based event platform 111 determines a user input for specifying at least one place type to associate with a user selection of a map, a portion of the map, or a combination thereof. In step 303, the platform 111 determines location information associated with the one or more context types and/or the one or more event types based on the user selection of the at least one place type.

In step 305, the place based event platform 111 processes the at least one place type to determine one or more context types, one or more event types, or a combination thereof associated with the map, the portion of the map, or a combination thereof. The place type, corresponding to the input, may be entered via the user interface of the application 107 of a map service 113 for presenting one or more maps. It is noted that the application 107 may be a browser application for accessing the map service 113 or a dedicated application for calling the map service 113 and/or place based event platform 111.

Per step 307, the platform 111 causes a rendering of the one or more context types and/or the one or more event types to a user interface of a device associated with the user concurrent with the map and/or the portion of the map. As noted previously, the rendering includes the generation and presentment of one or more objects, one or more messages, one or more map elements, one or more points-of-interest, or a combination thereof related to the one or more context types, the one or more event types, the map, the portion of the map, or a combination thereof.

In step 309 of process 308 (FIG. 3B), the place based platform 111 processes a user selection of at least one of the event types to determine one or more event sinks related to the at least one event type. As noted previously, the at least one event type is based on one or more ontological definitions. The ontological definitions may be specified by the various providers of the services for providing the event information. Of note, the defined ontology also enables cross service integration of event information as well as maintains a consistency across event types. Per step 311, the platform 111 causes a rendering of the one or more event sinks and/or one or more event sink detail entry fields to the user interface based on the at least one event type. Entry of the event details enables the user to receive notification of events to the specified sink.

In step 313, the platform 111 determines an occurrence of the at least one event type. The platform further causes transmission of information associated with the at least one event type based on the one or more event sinks. The information transmitted may be formatted for transmission based on a type of the one or more event sinks, i.e., by the event wrapping module of the place based event platform 111. As such, the platform 111 ensures the correct protocols are employed for facilitating conveyance of the information related to an event type.

In step 317 of process 316 (FIG. 3C), the place based event platform 111 processes the selection of the at least one context type to determine one or more context type subcategories associated with the at least one context type. In another step 319, the platform 111 determines a user input for specifying a name to associate with a selection of multiple context types and/or one or more context type subcategories. Per step 321, the place based event platform 111 causes a rendering of the name to the user interface based on the input concurrent with the map and/or the portion of the map. As noted previously, this corresponds to user based creation, merging and/or defining of a context type as an alternative to selection of a predefined context type.

In step 323 of process 322 (FIG. 3D), the place based event platform 111 processes one or more tag space definitions and/or one or more information types for defining a user context type and/or one or more user context type subcategories. The tag space definitions and/or information types may be specified by the one or more providers of the service 103. In another step 325, the platform 111 generates the user context type and/or the one or more user context type subcategories based on the definition.

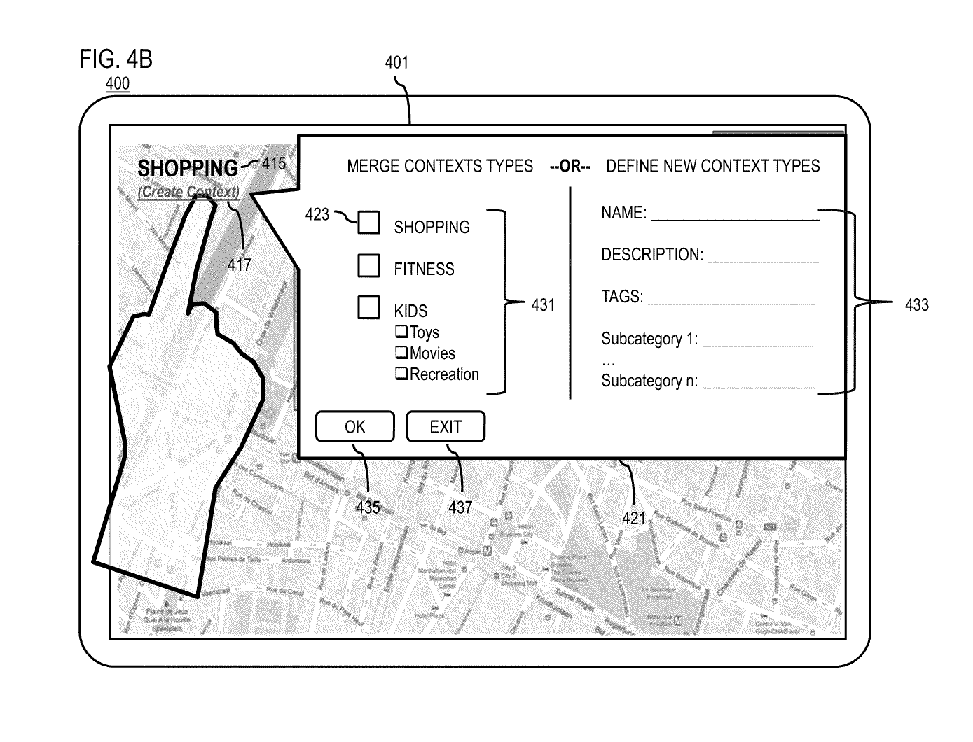

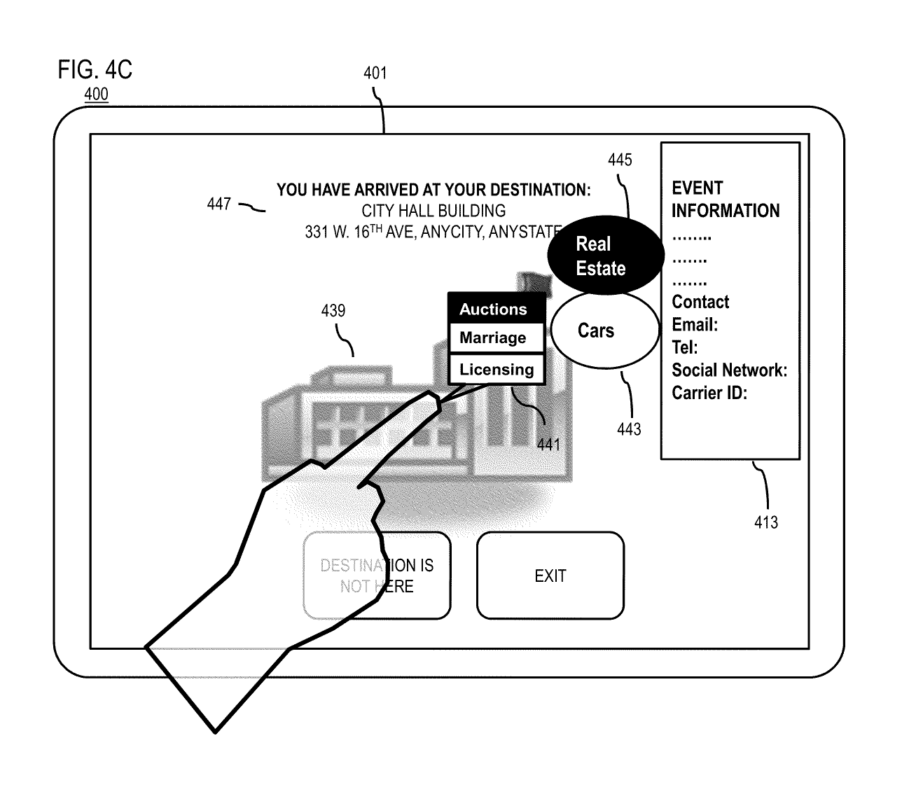

FIGS. 4A-4C are diagrams of user interfaces utilized in the processes of FIGS. 3A-3D, according to various embodiments. For the purpose of illustration, the interface is presented from the perspective of a use case of a user of a user device 401 that accesses a map service for rendering maps to a user interface 401. In this example, the map service calls for execution of the place based event platform 111 in response to user selection of an area 403 representing a place type.

In FIG. 4A, the interface 401 features various objects depicting streets, roads, buildings and other representations of elements corresponding to a map. By way of touch based input, the user highlights the area 403 on the interface. In response, the place based event platform 111 determines that the place type as selected (e.g., the highlighted area 403) corresponds to three different context types and renders these context types to the interface 403 as via a selection menu 405. By way of example, the context types include “Shopping,” “Fitness,” and “Kids.” In the case of the “Kids” context type, an expansion icon 419 is also presented to the user interface 401 for indicating that various subcategories of the context type may be selected (e.g., Toys, Movies and Recreation). The user may optionally select the expansion icon 419 to view the additional subcategories.

Based on the options, the user then selects the “Shopping” context type. As a result of this input, the selected context is presented as a caption 415 in the upper left hand corner of the user interface 401. In addition, a link 417 is presented for enabling the user to initiate the creation and/or defining of a new context type to associate with the selected place type (e.g., highlighted area 403). Also, upon selection of the “Shopping” context type 407, the place based event platform 111 determines the various event types associated with this selected context type and presents them as event type selection options 407-411. Under this scenario, the event types include “Shoe Deals,” Cloth Deals” and “Hair Store,” with each event type further being related to event information regarding the event type. The user may (optionally) interact with a selection option 407-411, i.e., tap and hold, to view the associated event information without activating that particular selection option.

In this example, when the user selects option 407 corresponding to the “Shoe Deals” event type, the place based event platform 111 causes rendering of the event information 413 for that event type. This may include a name of the host, sponsor of provider of the event, a contact address and phone number, a vendor identifier, details regarding the event, event cost data, etc. In addition, one or more event sinks related to the event along with associated data entry fields for receiving user input of event sink details are presented. Under this scenario, the data entry fields (as defined by a definition template) permit the user to specify which sinks they wish to receive shoe deal event notifications with when they occur. The event sinks types include email, telephone, social networking, and a cellular carrier identifier (e.g., for enabling carrier based map notifications). It is noted that only those sinks supported by the event type are presented.

As shown in FIG. 4B, when the user selects the link 417, a window 421 is presented for enabling the user to create a context type. In this example, the window 421 enables the user to merge predefined context types 431 and/or subcategories or define a new context type based on the input of one or more information types 433. Under this scenario, the user may select a check box (e.g., checkbox 423) corresponding to the particular context types they wish to merge. Also, the user may provide an input at a data entry field of for defining the context types 433 accordingly.

The window 421 also presents an EXIT action button 437 for permitting a user to close the window and return to the map view as depicted in FIG. 4A. Alternatively, the user may select an OK action button 435 for indicating completion of the defined context type. Once the OK action button 435 is selected, the caption 415 is updated to indicate the name of the newly defined context type.

In FIG. 4C, various context types are presented via a selection menu 441 as a result of user selection of a place type corresponding to an image 439. In this example, a navigation dialogue is presented to the user interface 401 for indicating that the user has arrived at their final destination. Hence, the navigation dialogue includes a notification message 447 for indicating the status of the navigation along with a name and address of the location of the user. In addition, the image 439 of the building corresponding to the location is shown as retrieved from a service 103.

Under this scenario, when the user taps the image 439, the place based event platform 111 accepts this input as indication of a place type and determines the various context types associated with this selection. By way of example, as the place type corresponds to a municipal building (e.g., City Hall Building), the associated context types include “Auctions,” “Marriage” and “Licensing.” When the user selects the “Auctions” context type, the place based event platform 111 further renders event type selection options 445 and 443, corresponding to event types “Real Estate” and “Cars” respectively. The user selects the “Real Estate” event type 445, which further prompts rendering of the related event information 413 and event sink date entry fields for enabling user notification of real estate auctions occurring the at City Hall Building.

It is noted, per this example, that the place type may include specific elements rendered to the user interface as shown per a map or per any user interface related to depicting various location based elements.

The processes described herein for identifying and subscribing to events of varying types/contexts based on a user selected place type may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

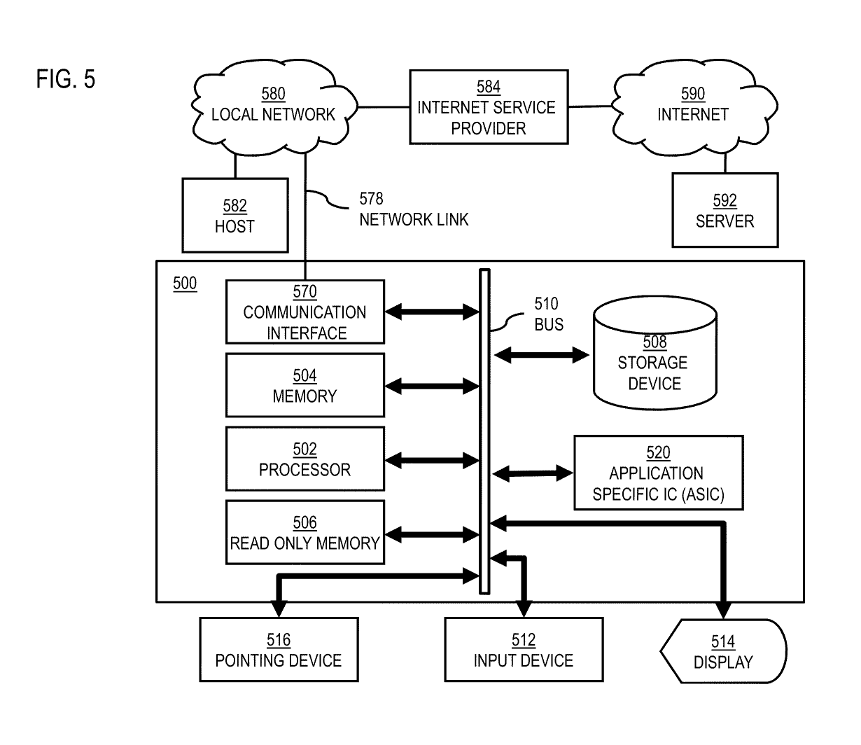

FIG. 5 illustrates a computer system 500 upon which an embodiment of the invention may be implemented. Although computer system 500 is depicted with respect to a particular device or equipment, it is contemplated that other devices or equipment (e.g., network elements, servers, etc.) within FIG. 5 can deploy the illustrated hardware and components of system 500. Computer system 500 is programmed (e.g., via computer program code or instructions) to identify and subscribe to events of varying types/contexts based on a user selected place type as described herein and includes a communication mechanism such as a bus 510 for passing information between other internal and external components of the computer system 500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 500, or a portion thereof, constitutes a means for performing one or more steps of identifying and subscribing to events of varying types/contexts based on a user selected place type.

A bus 510 includes one or more parallel conductors of information so that information is transferred quickly among devices coupled to the bus 510. One or more processors 502 for processing information are coupled with the bus 510.

A processor (or multiple processors) 502 performs a set of operations on information as specified by computer program code related to identify and subscribe to events of varying types/contexts based on a user selected place type. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 510 and placing information on the bus 510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 500 also includes a memory 504 coupled to bus 510. The memory 504, such as a random access memory (RAM) or any other dynamic storage device, stores information including processor instructions for identifying and subscribing to events of varying types/contexts based on a user selected place type. Dynamic memory allows information stored therein to be changed by the computer system 500. RAM allows a unit of information stored at a location called a memory address to be stored and retrieved independently of information at neighboring addresses. The memory 504 is also used by the processor 502 to store temporary values during execution of processor instructions. The computer system 500 also includes a read only memory (ROM) 506 or any other static storage device coupled to the bus 510 for storing static information, including instructions, that is not changed by the computer system 500. Some memory is composed of volatile storage that loses the information stored thereon when power is lost. Also coupled to bus 510 is a non-volatile (persistent) storage device 508, such as a magnetic disk, optical disk or flash card, for storing information, including instructions, that persists even when the computer system 500 is turned off or otherwise loses power.

Information, including instructions for identifying and subscribing to events of varying types/contexts based on a user selected place type, is provided to the bus 510 for use by the processor from an external input device 512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 500. Other external devices coupled to bus 510, used primarily for interacting with humans, include a display device 514, such as a cathode ray tube (CRT), a liquid crystal display (LCD), a light emitting diode (LED) display, an organic LED (OLED) display, a plasma screen, or a printer for presenting text or images, and a pointing device 516, such as a mouse, a trackball, cursor direction keys, or a motion sensor, for controlling a position of a small cursor image presented on the display 514 and issuing commands associated with graphical elements presented on the display 514. In some embodiments, for example, in embodiments in which the computer system 500 performs all functions automatically without human input, one or more of external input device 512, display device 514 and pointing device 516 is omitted.

In the illustrated embodiment, special purpose hardware, such as an application specific integrated circuit (ASIC) 520, is coupled to bus 510. The special purpose hardware is configured to perform operations not performed by processor 502 quickly enough for special purposes. Examples of ASICs include graphics accelerator cards for generating images for display 514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 500 also includes one or more instances of a communications interface 570 coupled to bus 510. Communication interface 570 provides a one-way or two-way communication coupling to a variety of external devices that operate with their own processors, such as printers, scanners and external disks. In general the coupling is with a network link 578 that is connected to a local network 580 to which a variety of external devices with their own processors are connected. For example, communication interface 570 may be a parallel port or a serial port or a universal serial bus (USB) port on a personal computer. In some embodiments, communications interface 570 is an integrated services digital network (ISDN) card or a digital subscriber line (DSL) card or a telephone modem that provides an information communication connection to a corresponding type of telephone line. In some embodiments, a communication interface 570 is a cable modem that converts signals on bus 510 into signals for a communication connection over a coaxial cable or into optical signals for a communication connection over a fiber optic cable. As another example, communications interface 570 may be a local area network (LAN) card to provide a data communication connection to a compatible LAN, such as Ethernet. Wireless links may also be implemented. For wireless links, the communications interface 570 sends or receives or both sends and receives electrical, acoustic or electromagnetic signals, including infrared and optical signals, that carry information streams, such as digital data. For example, in wireless handheld devices, such as mobile telephones like cell phones, the communications interface 570 includes a radio band electromagnetic transmitter and receiver called a radio transceiver. In certain embodiments, the communications interface 570 enables connection to the communication network 105 for identifying and subscribing to events of varying types/contexts based on a user selected place type to the UE 101.

The term “computer-readable medium” as used herein refers to any medium that participates in providing information to processor 502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 508. Volatile media include, for example, dynamic memory 504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 520.

Network link 578 typically provides information communication using transmission media through one or more networks to other devices that use or process the information. For example, network link 578 may provide a connection through local network 580 to a host computer 582 or to equipment 584 operated by an Internet Service Provider (ISP). ISP equipment 584 in turn provides data communication services through the public, world-wide packet-switching communication network of networks now commonly referred to as the Internet 590.

A computer called a server host 592 connected to the Internet hosts a process that provides a service in response to information received over the Internet. For example, server host 592 hosts a process that provides information representing video data for presentation at display 514. It is contemplated that the components of system 500 can be deployed in various configurations within other computer systems, e.g., host 582 and server 592.

At least some embodiments of the invention are related to the use of computer system 500 for implementing some or all of the techniques described herein. According to one embodiment of the invention, those techniques are performed by computer system 500 in response to processor 502 executing one or more sequences of one or more processor instructions contained in memory 504. Such instructions, also called computer instructions, software and program code, may be read into memory 504 from another computer-readable medium such as storage device 508 or network link 578. Execution of the sequences of instructions contained in memory 504 causes processor 502 to perform one or more of the method steps described herein. In alternative embodiments, hardware, such as ASIC 520, may be used in place of or in combination with software to implement the invention. Thus, embodiments of the invention are not limited to any specific combination of hardware and software, unless otherwise explicitly stated herein.

The signals transmitted over network link 578 and other networks through communications interface 570, carry information to and from computer system 500. Computer system 500 can send and receive information, including program code, through the networks 580, 590 among others, through network link 578 and communications interface 570. In an example using the Internet 590, a server host 592 transmits program code for a particular application, requested by a message sent from computer 500, through Internet 590, ISP equipment 584, local network 580 and communications interface 570. The received code may be executed by processor 502 as it is received, or may be stored in memory 504 or in storage device 508 or any other non-volatile storage for later execution, or both. In this manner, computer system 500 may obtain application program code in the form of signals on a carrier wave.

Various forms of computer readable media may be involved in carrying one or more sequence of instructions or data or both to processor 502 for execution. For example, instructions and data may initially be carried on a magnetic disk of a remote computer such as host 582. The remote computer loads the instructions and data into its dynamic memory and sends the instructions and data over a telephone line using a modem. A modem local to the computer system 500 receives the instructions and data on a telephone line and uses an infra-red transmitter to convert the instructions and data to a signal on an infra-red carrier wave serving as the network link 578. An infrared detector serving as communications interface 570 receives the instructions and data carried in the infrared signal and places information representing the instructions and data onto bus 510. Bus 510 carries the information to memory 504 from which processor 502 retrieves and executes the instructions using some of the data sent with the instructions. The instructions and data received in memory 504 may optionally be stored on storage device 508, either before or after execution by the processor 502.

FIG. 6 illustrates a chip set or chip 600 upon which an embodiment of the invention may be implemented. Chip set 600 is programmed to identify and subscribe to events of varying types/contexts based on a user selected place type as described herein and includes, for instance, the processor and memory components described with respect to FIG. 5 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 600 can be implemented in a single chip. It is further contemplated that in certain embodiments the chip set or chip 600 can be implemented as a single “system on a chip.” It is further contemplated that in certain embodiments a separate ASIC would not be used, for example, and that all relevant functions as disclosed herein would be performed by a processor or processors. Chip set or chip 600, or a portion thereof, constitutes a means for performing one or more steps of providing user interface navigation information associated with the availability of functions. Chip set or chip 600, or a portion thereof, constitutes a means for performing one or more steps of identifying and subscribing to events of varying types/contexts based on a user selected place type.

In one embodiment, the chip set or chip 600 includes a communication mechanism such as a bus 601 for passing information among the components of the chip set 600. A processor 603 has connectivity to the bus 601 to execute instructions and process information stored in, for example, a memory 605. The processor 603 may include one or more processing cores with each core configured to perform independently. A multi-core processor enables multiprocessing within a single physical package. Examples of a multi-core processor include two, four, eight, or greater numbers of processing cores. Alternatively or in addition, the processor 603 may include one or more microprocessors configured in tandem via the bus 601 to enable independent execution of instructions, pipelining, and multithreading. The processor 603 may also be accompanied with one or more specialized components to perform certain processing functions and tasks such as one or more digital signal processors (DSP) 607, or one or more application-specific integrated circuits (ASIC) 609. A DSP 607 typically is configured to process real-world signals (e.g., sound) in real time independently of the processor 603. Similarly, an ASIC 609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 600 includes merely one or more processors and some software and/or firmware supporting and/or relating to and/or for the one or more processors.

The processor 603 and accompanying components have connectivity to the memory 605 via the bus 601. The memory 605 includes both dynamic memory (e.g., RAM, magnetic disk, writable optical disk, etc.) and static memory (e.g., ROM, CD-ROM, etc.) for storing executable instructions that when executed perform the inventive steps described herein to identify and subscribe to events of varying types/contexts based on a user selected place type. The memory 605 also stores the data associated with or generated by the execution of the inventive steps.

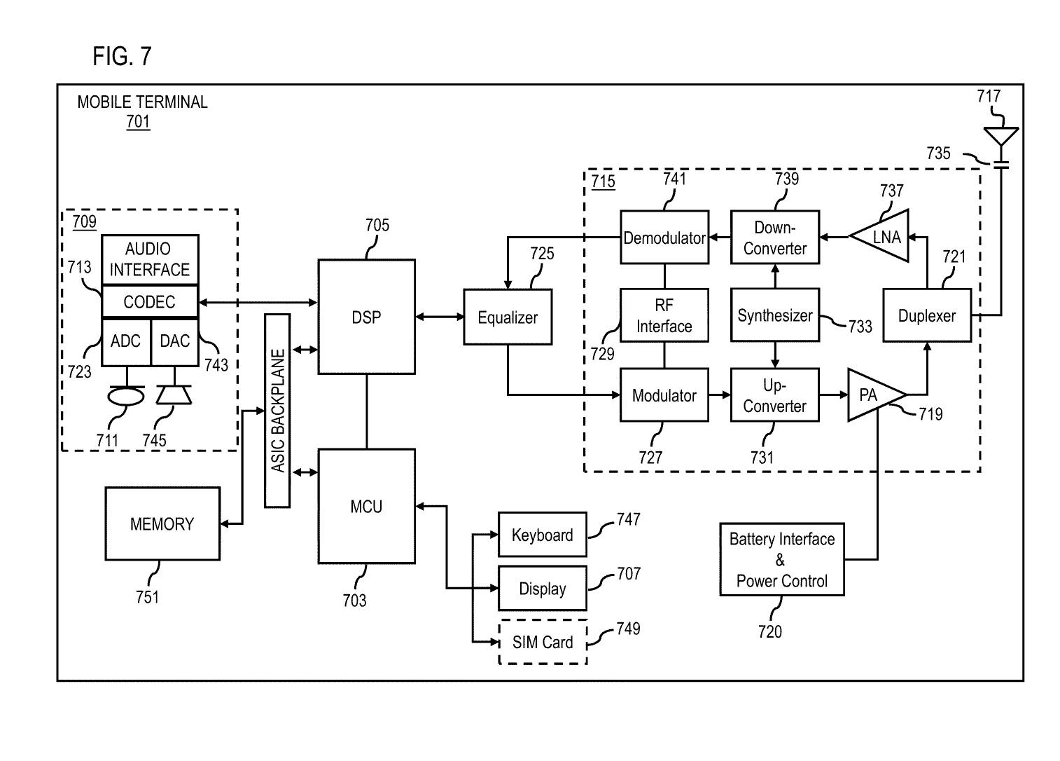

FIG. 7 is a diagram of exemplary components of a mobile terminal (e.g., handset) for communications, which is capable of operating in the system of FIG. 1, according to one embodiment. In some embodiments, mobile terminal 701, or a portion thereof, constitutes a means for performing one or more steps of identifying and subscribing to events of varying types/contexts based on a user selected place type. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 703, a Digital Signal Processor (DSP) 705, and a receiver/transmitter unit including a microphone gain control unit and a speaker gain control unit. A main display unit 707 provides a display to the user in support of various applications and mobile terminal functions that perform or support the steps of identifying and subscribing to events of varying types/contexts based on a user selected place type. The display 707 includes display circuitry configured to display at least a portion of a user interface of the mobile terminal (e.g., mobile telephone). Additionally, the display 707 and display circuitry are configured to facilitate user control of at least some functions of the mobile terminal. An audio function circuitry 709 includes a microphone 711 and microphone amplifier that amplifies the speech signal output from the microphone 711. The amplified speech signal output from the microphone 711 is fed to a coder/decoder (CODEC) 713.

A radio section 715 amplifies power and converts frequency in order to communicate with a base station, which is included in a mobile communication system, via antenna 717. The power amplifier (PA) 719 and the transmitter/modulation circuitry are operationally responsive to the MCU 703, with an output from the PA 719 coupled to the duplexer 721 or circulator or antenna switch, as known in the art. The PA 719 also couples to a battery interface and power control unit 720.

In use, a user of mobile terminal 701 speaks into the microphone 711 and his or her voice along with any detected background noise is converted into an analog voltage. The analog voltage is then converted into a digital signal through the Analog to Digital Converter (ADC) 723. The control unit 703 routes the digital signal into the DSP 705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 725 for compensation of any frequency-dependent impairments that occur during transmission though the air such as phase and amplitude distortion. After equalizing the bit stream, the modulator 727 combines the signal with a RF signal generated in the RF interface 729. The modulator 727 generates a sine wave by way of frequency or phase modulation. In order to prepare the signal for transmission, an up-converter 731 combines the sine wave output from the modulator 727 with another sine wave generated by a synthesizer 733 to achieve the desired frequency of transmission. The signal is then sent through a PA 719 to increase the signal to an appropriate power level. In practical systems, the PA 719 acts as a variable gain amplifier whose gain is controlled by the DSP 705 from information received from a network base station. The signal is then filtered within the duplexer 721 and optionally sent to an antenna coupler 735 to match impedances to provide maximum power transfer. Finally, the signal is transmitted via antenna 717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 701 are received via antenna 717 and immediately amplified by a low noise amplifier (LNA) 737. A down-converter 739 lowers the carrier frequency while the demodulator 741 strips away the RF leaving only a digital bit stream. The signal then goes through the equalizer 725 and is processed by the DSP 705. A Digital to Analog Converter (DAC) 743 converts the signal and the resulting output is transmitted to the user through the speaker 745, all under control of a Main Control Unit (MCU) 703 which can be implemented as a Central Processing Unit (CPU).

The MCU 703 receives various signals including input signals from the keyboard 747. The keyboard 747 and/or the MCU 703 in combination with other user input components (e.g., the microphone 711) comprise a user interface circuitry for managing user input. The MCU 703 runs a user interface software to facilitate user control of at least some functions of the mobile terminal 701 to identify and subscribe to events of varying types/contexts based on a user selected place type. The MCU 703 also delivers a display command and a switch command to the display 707 and to the speech output switching controller, respectively. Further, the MCU 703 exchanges information with the DSP 705 and can access an optionally incorporated SIM card 749 and a memory 751. In addition, the MCU 703 executes various control functions required of the terminal. The DSP 705 may, depending upon the implementation, perform any of a variety of conventional digital processing functions on the voice signals. Additionally, DSP 705 determines the background noise level of the local environment from the signals detected by microphone 711 and sets the gain of microphone 711 to a level selected to compensate for the natural tendency of the user of the mobile terminal 701.

The CODEC 713 includes the ADC 723 and DAC 743. The memory 751 stores various data including call incoming tone data and is capable of storing other data including music data received via, e.g., the global Internet. The software module could reside in RAM memory, flash memory, registers, or any other form of writable storage medium known in the art. The memory device 751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 749 carries, for instance, important information, such as the cellular phone number, the carrier supplying service, subscription details, and security information. The SIM card 749 serves primarily to identify the mobile terminal 701 on a radio network. The card 749 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a user input for specifying at least one place type to associate with a user selection of a map, a portion of the map, or a combination thereof; and
a processing of the at least one place type to determine one or more context types, one or more event types, or a combination thereof associated with the map, the portion of the map, or a combination thereof.

2. A method of claim 1, wherein the (1) data and/or (2) information and/or (3) at least one signal are further based, at least in part, on the following:
a rendering of the one or more context types, the one or more event types, or a combination thereof to a user interface of a device associated with the user concurrent with the map, the portion of the map, or a combination thereof,
wherein the rendering includes one or more objects, one or more messages, one or more map elements, one or more points-of-interest, or a combination thereof related to the one or more context types, the one or more event types, the map, the portion of the map, or a combination thereof.

3. A method of claim 2, wherein the (1) data and/or (2) information and/or (3) at least one signal are further based, at least in part, on the following:
at least one determination of location information associated with the one or more context types, the one or more event types, or a combination thereof based, at least in part, on the user selection of the at least one place type.

4. A method of claim 1, wherein the (1) data and/or (2) information and/or (3) at least one signal are further based, at least in part, on the following:
a processing of a user selection of at least one of the event types to determine one or more event sinks related to the at least one event type; and
a rendering of the one or more event sinks, one or more event sink detail entry fields, or a combination thereof to the user interface based, at least in part, on the at least one event type,
wherein the at least one event type is based on one or more ontological definitions.

5. A method of claim 4, wherein the (1) data and/or (2) information and/or (3) at least one signal are further based, at least in part, on the following:
an occurrence of the at least one event type; and
a transmission of information associated with the at least one event type based, at least in part, on the one or more event sinks.

6. A method of claim 5, wherein the information is formatted for transmission based on a type of the one or more event sinks.

7. A method of claim 1, wherein the (1) data and/or (2) information and/or (3) at least one signal are further based, at least in part, on the following:
a processing of the at least one context type to determine one or more context type subcategories associated with the at least one context type.

8. A method of claim 7, wherein the (1) data and/or (2) information and/or (3) at least one signal are further based, at least in part, on the following:
a user input for specifying a name to associate with a selection of multiple context types, one or more context type subcategories, or a combination thereof; and
a rendering of the name to the user interface based, at least in part, on the input concurrent with the map, the portion of the map, or a combination thereof.

9. A method of claim 8, wherein the context types, the one or more context type subcategories, or a combination thereof are defined by one or more data providers.

10. A method of claim 1, wherein the (1) data and/or (2) information and/or (3) at least one signal are further based, at least in part, on the following:
a processing of one or more tag space definitions, one or more information types, or a combination thereof for defining a user context type, one or more user context type subcategories, or a combination thereof; and
a generating of the user context type, the one or more user context type subcategories, or a combination thereof based, at least in part, on the definition.

11. An apparatus comprising:
at least one processor; and
at least one memory including computer program code for one or more programs,
the at least one memory and the computer program code configured to, with the at least one processor, cause the apparatus to perform at least the following,
determine a user input for specifying at least one place type to associate with a user selection of a map, a portion of the map, or a combination thereof; and
process and/or facilitate a processing of the at least one place type to determine one or more context types, one or more event types, or a combination thereof associated with the map, the portion of the map, or a combination thereof.

12. An apparatus of claim 11, wherein the apparatus is further caused to:
cause, at least in part, a rendering of the one or more context types, the one or more event types, or a combination thereof to a user interface of a device associated with the user concurrent with the map, the portion of the map, or a combination thereof,
wherein the rendering includes one or more objects, one or more messages, one or more map elements, one or more points-of-interest, or a combination thereof related to the one or more context types, the one or more event types, the map, the portion of the map, or a combination thereof.

13. An apparatus of claim 11, wherein the apparatus is further caused to:
determine location information associated with the one or more context types, the one or more event types, or a combination thereof based, at least in part, on the user selection of the at least one place type.

14. An apparatus of claim 11, wherein the apparatus is further caused to:
process and/or facilitate a processing of a user selection of at least one of the event types to determine one or more event sinks related to the at least one event type; and
cause, at least in part, a rendering of the one or more event sinks, one or more event sink detail entry fields, or a combination thereof to the user interface based, at least in part, on the at least one event type,
wherein the at least one event type is based on one or more ontological definitions.

15. An apparatus of claim 14, wherein the apparatus is further caused to:
determine an occurrence of the at least one event type; and
cause, at least in part, transmission of information associated with the at least one event type based, at least in part, on the one or more event sinks.

16. An apparatus of claim 15, wherein the information is formatted for transmission based on a type of the one or more event sinks.

17. An apparatus of claim 11, wherein the apparatus is further caused to:
process and/or facilitate a processing of the at least one context type to determine one or more context type subcategories associated with the at least one context type.

18. An apparatus of claim 17, wherein the apparatus is further caused to:
determine a user input for specifying a name to associate with a selection of multiple context types, one or more context type subcategories, or a combination thereof; and
cause, at least in part, a rendering of the name to the user interface based, at least in part, on the input concurrent with the map, the portion of the map, or a combination thereof.

19. An apparatus of claim 18, wherein the context types, the one or more context type subcategories, or a combination thereof are defined by one or more data providers.

20. An apparatus of claim 11, wherein the apparatus is further caused to:
process and/or facilitate a processing of one or more tag space definitions, one or more information types, or a combination thereof for defining a user context type, one or more user context type subcategories, or a combination thereof; and
generate the user context type, the one or more user context type subcategories, or a combination thereof based, at least in part, on the definition.

21-48. (canceled)
